(19) United States
(12) Patent Application Publication
(10) Pub. No.: US 2023/0169219 A1
(43) Pub. Date: Jun. 1, 2023

(54) SERVER SYSTEMS AND METHODS FOR REDUCING CARBON AND SULFUR FOOTPRINT

(71) Applicant: AVEVA SOFTWARE, LLC, Lake Forest, CA (US)

(72) Inventors: Abinay Reddy Bethi, Hyderabad (IN); Pavan Kumar Panuganti, Hyderabad (IN); Tejaswi Tigala, Hyderabad (IN)

(21) Appl. No.: 18/072,099

(22) Filed: Nov. 30, 2022

Related U.S. Application Data
(60) Provisional application No. 63/284,275, filed on Nov. 30, 2021.

(51) Int. Cl. G06F 30/12

(52) U.S. Cl. CPC G06F 30/12; G06F 2111/20

(57) ABSTRACT

The disclosure is directed to a system for integrating pollution absorbing components into a simulation model. In some embodiments, the system includes a pollution model library which includes model components representing pollution absorbing structures. In some embodiments, the system includes a simulation canvas where the pollution absorbing structures can be integrated with emission producing components. In some embodiments, the system is configured to analyze the effect that a pollution absorbing structure has on an emission output from the emission producing components. In some embodiments, the system is configured to display resulting carbon output from various simulated configurations.

### CROSS-REFERENCE TO RELATED APPLICATION

This application claims the benefit of and priority to U.S. Provisional Application No. 63/284,275, filed Nov. 30, 2021, which is incorporated herein by reference in its entirety.

### BACKGROUND

There is a race to zero emissions to reduce the pollution footprint on the environment. Companies are taking measures such as not including charging adaptors and reinventing packaging options to eliminate even the smallest contributors to environmental degradation.

Many manufacturing processes create pollution and pollution byproducts including greenhouse gases. A company's carbon footprint is the total greenhouse gas emissions (mainly consisting of CO2, CH4, N2O, etc.) caused one or more individuals, event, organizations, services, places or products. Implementing systems to reduce greenhouse gasses are increasingly important as major organizations continue to search for creative ways to become carbon neutral companies.

Currently, there is not an effective way to assess multiple pollution absorbing systems when designing manufacturing facilities. This is because whenever new components are introduced into a facility model, the total effects must be recalculated. In the current state of the art, these calculations at most are done through mass balance equations by hand, and each pollution reduction solution must be manually created specific for each facility model. This inefficient process is compounded by the fact that regulatory requirements differ from one geographical location to the next, so every emission reduction system must be specific to both the type of manufacturing facility and its geographical location.

Therefore, there is a need in the art for a simulation system that enables the selection modeling and importation of multiple pollution reduction systems to model and achieve emissions at an acceptable level.

### SUMMARY

In some embodiments, systems and methods described herein (referred to throughout this disclosure as the “system”) are directed to improving simulation software and environmental conditions by providing easily integratable pollution absorbing structures into a simulation model. In some embodiments, the system comprises one or more computers comprising one or more processor and one or more non-transitory computer readable media with computer implemented instructions stored thereon. In some embodiments, the instructions include a simulation module, a pollutant module, and a geography module.

In some embodiments, the simulation module is configured to generate a simulation environment that includes a toolbar, a simulation model library, and a simulation canvas. In some embodiments, the toolbar comprises various buttons icons, and/or actuators to customize and/or store simulations built on the simulation canvas. The model library comprises various customizable model components that include icons that represent components in a manufacturing process. Each model component can be assigned various parameters such as equations that represent flowrate, temperature, pressure, and/or any conventional parameter found within a manufacturing facility that can be modeled mathematically. When connected to each other on the simulation canvas, the simulation module is configured to analyze each component's effect on the overall structure as well as the effect each component has on each other. As a result, the actual operating conditions of a real manufacturing facility can be represented by the simulation model.

In some embodiments, the pollutant module is configured to generate a pollution absorption model library comprising pre-built systems configured to absorb various types of pollutant emissions. In some embodiments, upon execution, the pollutant module is configured to interface with the simulation module. In some embodiments, the pollutant module is configured to add the pollution absorption model library or other desired pollution mitigation model libraires to the simulation model library upon execution. In some embodiments, upon execution, the pollutant module is configured to add a pollutant canvas to the simulation environment.

In some embodiments, the pollutant canvas is configured to show the total emissions of the modeled system for one or more types of pollutants (e.g., greenhouse gasses). In some embodiments, the pollutant canvas is configured to enable a user to set an upper limit on one or more pollutants as a recommended level. In some embodiments, the pollutant module is configured to automatically add one or more pre-built pollutant absorbing and/or attending systems (hereinafter “pollutant absorbing systems”) to the pollution absorption model library based on the recommended level for each pollutant.

In some embodiments, upon execution, the pollutant module is configured to interface with the geographical module. In some embodiments, the geography module is configured to enable a user to input a specific geographic region where the actual system is or will be built. In some embodiments, the geographical module is configured to determine the location where the simulation is being executed and set the geographical region based on the user's location. In some embodiments, the geographical module is configured to automatically load one or more pre-built pollution absorbing systems into the pollutant model library that can be connected to the manufacturing facility model and/or that are available in that region. This automatic loading of pollutant absorbing models specific to a geographic region saves valuable computer resources by not loading models that are incompatible with the emissions produced by the actual system or are unavailable due to regional constraints.

In some embodiments, one or more pre-built pollutant absorbing models can be imported into the simulation canvas from the (combined) model library. In some embodiments, a pre-built pollutant absorbing model remains passive until connected to one or more emission producing components in the manufacturing model highlighted by the system. In some embodiments, if the simulation is run before the pollutant absorbing model is connected, only the manufacturing model and resulting emissions are displayed along with the unmitigated pollutants on the simulation canvas. In some embodiments, after connection, the simulation canvas is configured to display the results of the entire structure as a whole including the emissions with the pollutant absorbing model attached. If one pollutant absorbing model does not reduce one or more emissions passed the recommended amount, the model can be replaced and/or additional models can be added to the simulation canvas until the desired emissions level(s) is achieved.

In some embodiments, the simulation module is configured to interface with one or more supervisory control and data acquisitions (SCADA) systems in order to control one or more actual components represented by the model components on the simulation canvas. In some embodiments, a manufacturing facility may have multiple pollutant reduction structures connected to various portions of the plant that handle different types of pollutants. In some embodiments, the simulation module and/or pollutant module are configured to analyze the manufacturing model based on the specific raw material supplied to determine the location and types of emissions the raw material produces. In some embodiments, the system is configured to automatically change a valve or other component line-up in order to direct the emissions to the most effective, most desirable and/or online pollutant reduction structure available.

### DRAWING DESCRIPTION

FIG. 1 shows a non-limiting example process simulator according to some embodiments.

FIG. 2 illustrates the activation of the pollutant module by actuation of a pollutant button located in the toolbar according to some embodiments.

FIG. 3 illustrates the results of the pollutant module calculations for the carbon production model.

FIG. 4 is a zoomed view of the simulation canvas before the carbon production system is integrated with the carbon absorption system according to some embodiments.

FIG. 5 depicts connecting the carbon production system with the carbon absorption system by dragging the vent to an inlet node.

FIG. 6 illustrates the completed connection between the carbon production system and the carbon absorption system by connection line.

FIG. 7 shows initiating the connection between the systems to result in a single model.

FIG. 8 shows a flowsheet status window which also comprises a run simulation button.

FIG. 9 shows the pollutant footprint table displaying the recalculated emission values according to some embodiments.

FIG. 10 illustrates a computer system enabling or comprising the systems and methods in accordance with some embodiments of the system.

FIG. 11 is a flowchart depicting instruction for the execution of the systems and methods described herein.

### DETAILED DESCRIPTION

The following detailed description is a non-limiting example of a simulator executing the systems and methods described herein according to some embodiments. It is understood that the system can take various forms and arrangements, and that the following disclosure of the system's implementation is only to aid those of ordinary skill in making and using the system by borrowing from various embodiments presented herein. In the figures, the first number denotes the figure number and remaining digits denote the object, where like objects have the same object number. Please note that while the term “carbon” is used extensively for this particular example the system is capable of performing equally for any type of pollutant, and the term “carbon” can be readily exchanged for “pollutant” when defining the metes and bounds of the system.

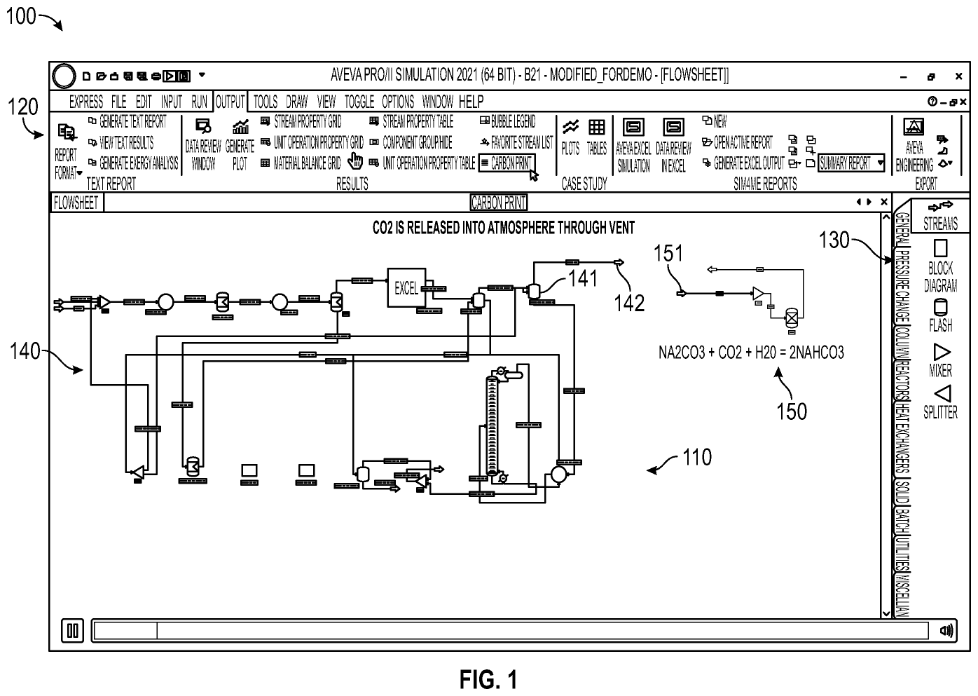

FIG. 1 shows a non-limiting example process simulator 100 according to some embodiments. In some embodiments, the simulator includes a simulation canvas 110, a toolbar 120, and a model library 130. A carbon production model 140 has been constructed on the simulation canvas 110 and its various components have been configured to accurately model the accumulation of carbon dioxide (CO₂) within the actual structure according to some embodiments. In some embodiments, the carbon production model 140 is configured to release carbon dioxide through a vent 141 currently set to atmosphere as indicated by the open-ended vent line 142.

In some embodiments, a carbon absorption model 150 has been selected from the model library 130 and imported into the simulation canvas 110. At this stage, the carbon absorption model 150 is not connected by an inlet line 151 to vent line 142 and is passive on the simulation canvas 110 such that it is not included in any model calculations.

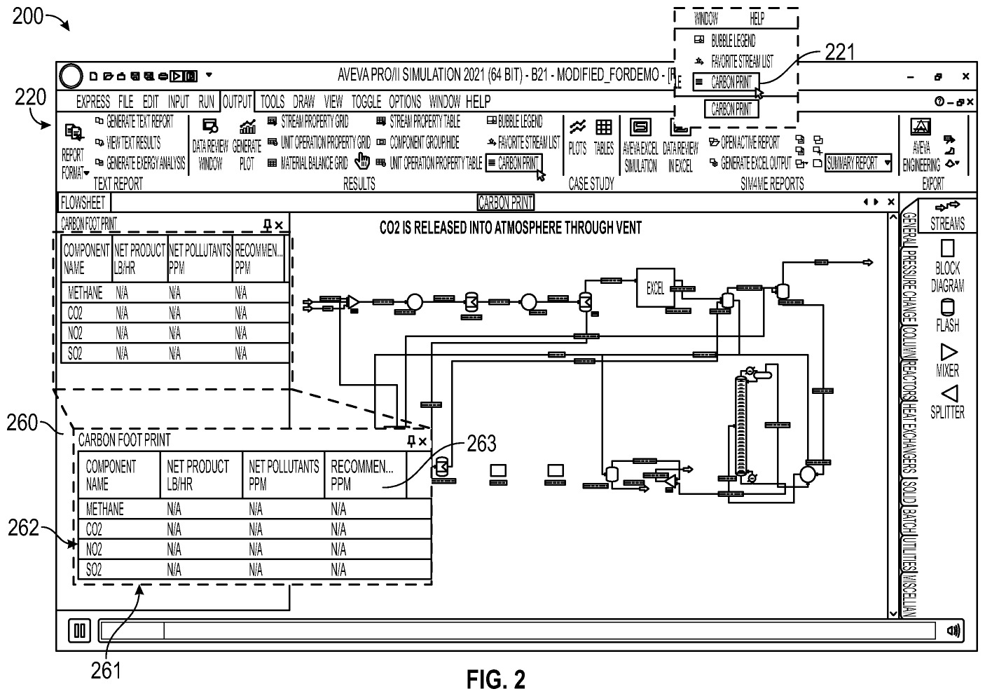

FIG. 2 illustrates the activation of the pollutant module by actuation of a pollutant button 221 located in the toolbar 220 according to some embodiments. In some embodiments, once initiated, the pollutant module is configured to display a pollutant canvas 260. In some embodiments, the pollutant canvas 260 comprises a pollutant footprint table 261 configured to display one or more pollutant calculations 262. In some embodiments, the pollutant footprint table 261 includes a recommended column 263 which is configured to set the upper limit on emissions.

In some embodiments, the system includes a geographical module configured to automatically populate the recommended column 263 with limits set by local regulatory commissions. In some embodiments, the geographical module is configured to automatically determine the location of where the simulation software is being executed and apply recommendations based on the user's location. In some embodiments, the toolbar 220 comprises a geography button (not shown) which generates a window configured to enable a user to set the geographic location of the real manufacturing facility structure.

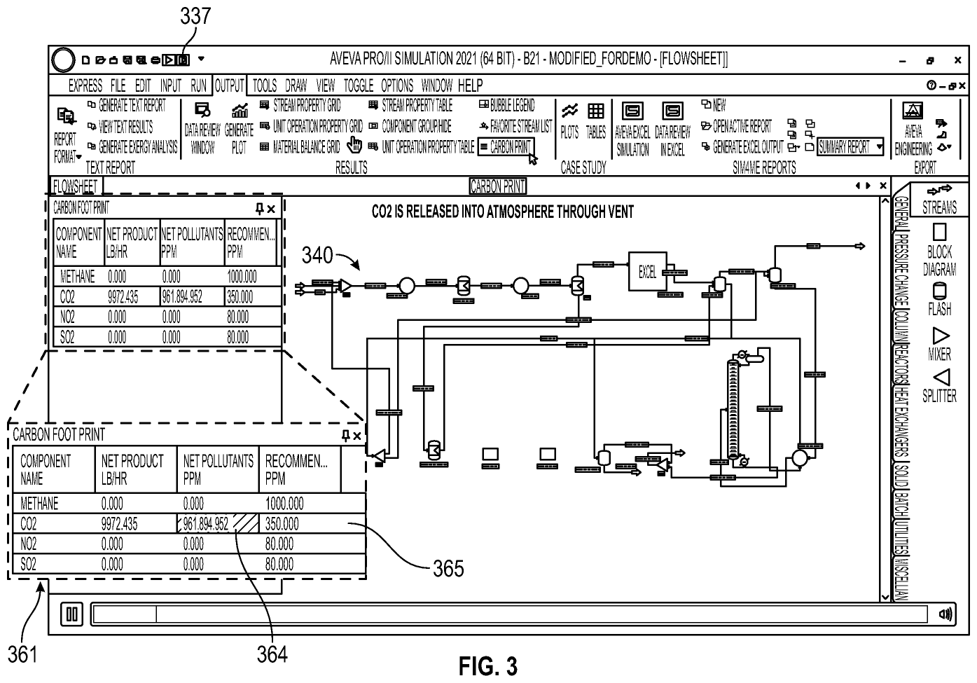

FIG. 3 illustrates the results of the pollutant module calculations for the carbon production model 340. In some embodiments, the pollutant module is configured to categorize and/or sum all pollutants generated by the carbon production system 340. As shown, the net pollutants parts per million (PPM) for CO₂ emissions 364 far exceed the recommended PPM for CO₂ 365.

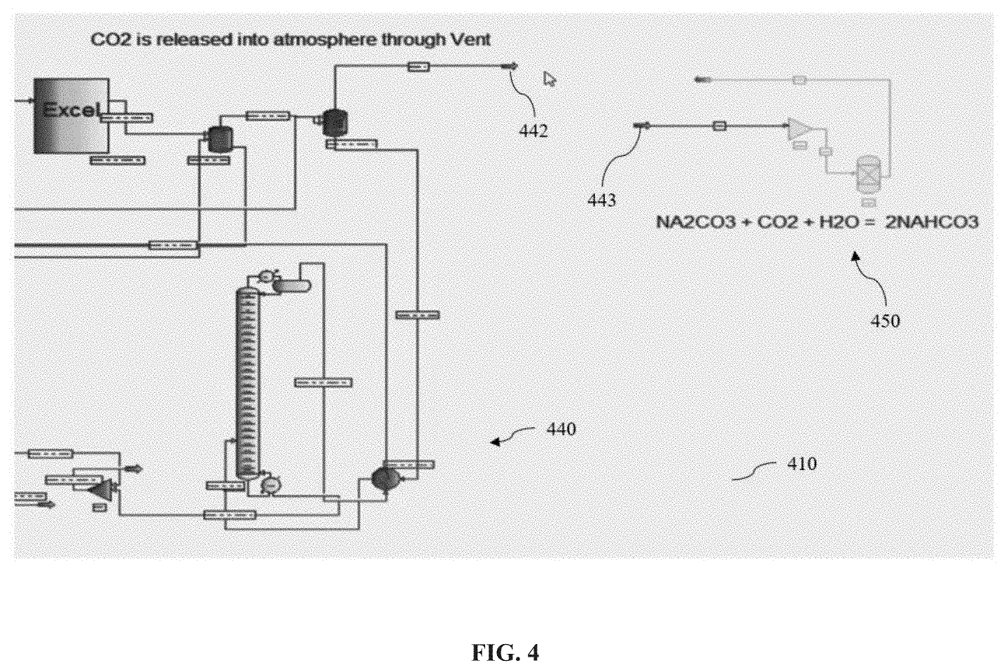

FIG. 4 is a zoomed view of the simulation canvas 410 before the carbon production system 440 is integrated with the carbon absorption system 450 according to some embodiments. As shown, there is a gap on the simulation canvas 410 between the vent 442 and the inlet 443.

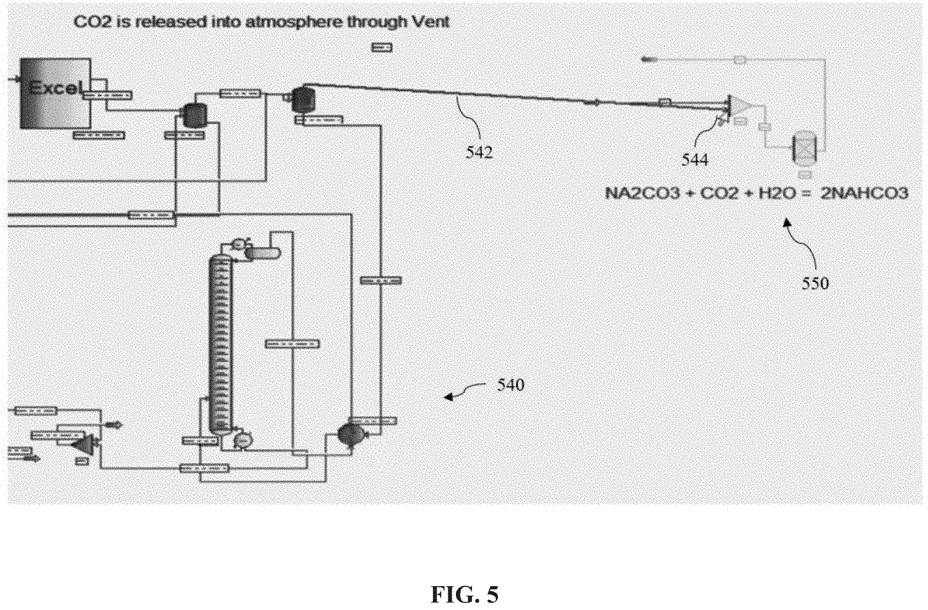

FIG. 5 depicts connecting the carbon production system 540 with the carbon absorption system 550 by dragging the vent 542 to an inlet node 544.

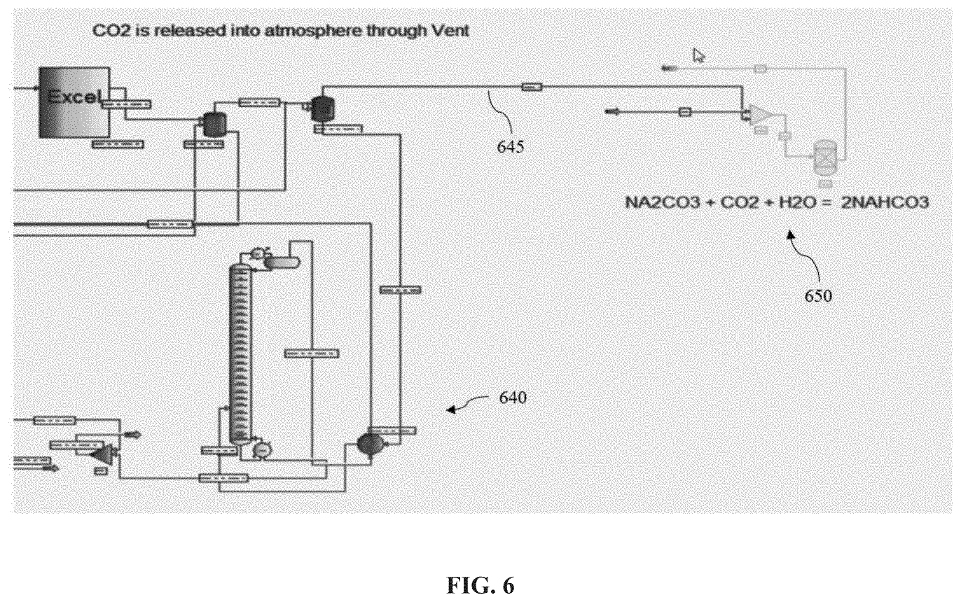

FIG. 6 illustrates the completed connection between the carbon production system 540 and the carbon absorption system 550 by connection line 645.

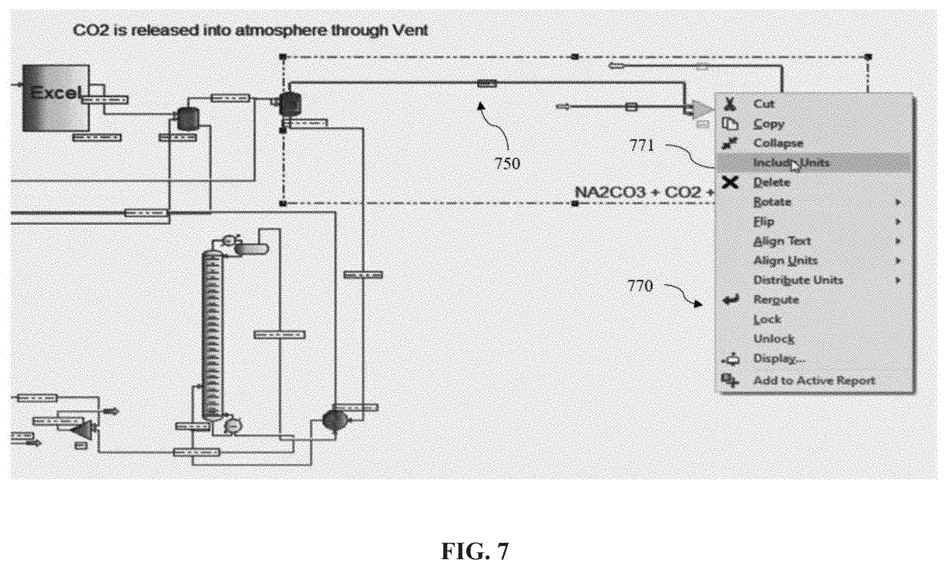

FIG. 7 shows initiating the connection between the systems to result in a single model. In some embodiments, by right-clicking on the carbon absorption system 750 and selecting include units 771 on the window 770 the integration is completed. In some embodiments, upon completing the connection the pollutant module factors in the emission reduction contributions from carbon absorption system 750 when determining total pollutant output.

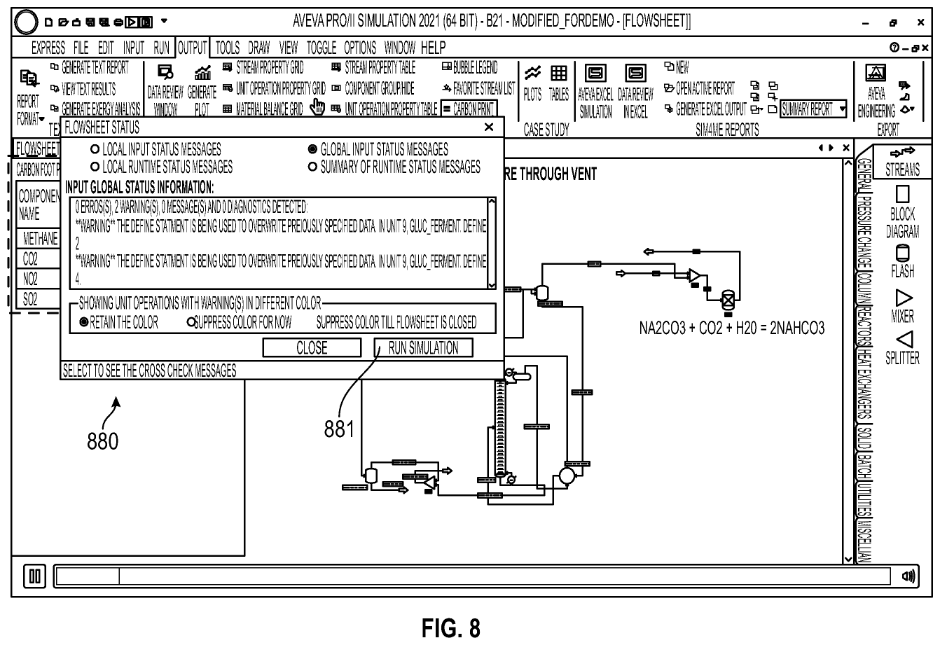

FIG. 8 shows a flowsheet status window 880 which also comprises a run simulation button 881, although icons or other actuators or actuation aids can be substituted for any button described herein.

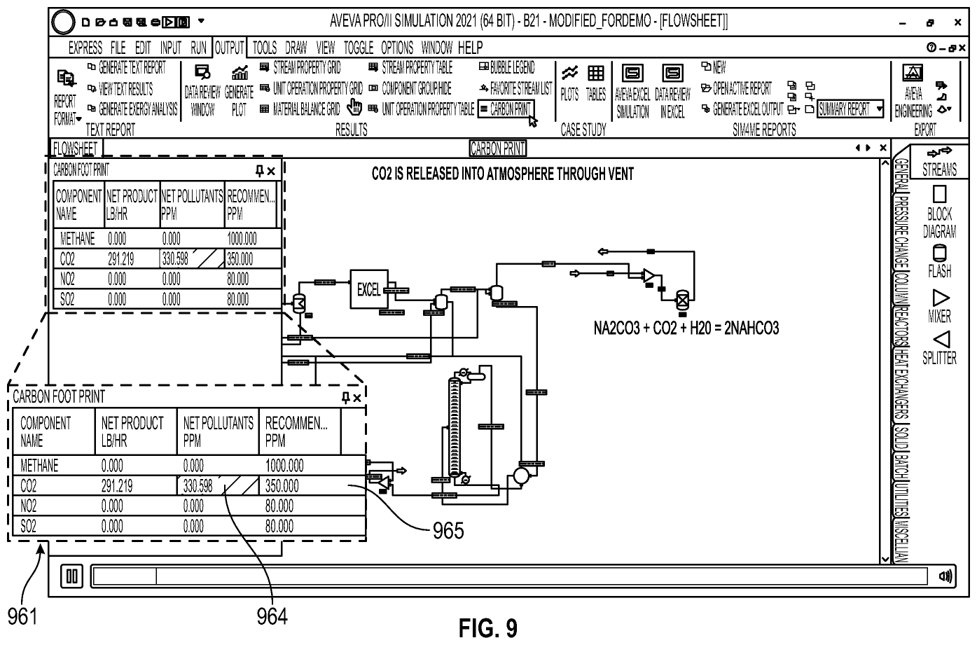

FIG. 9 shows the pollutant footprint table 961 displaying the recalculated emission values according to some embodiments. As shown, the net pollutants 964 is below the recommended pollutants 965 and is therefore acceptable as highlighted in green or other desired color or highlighted in other manners according to some embodiments.

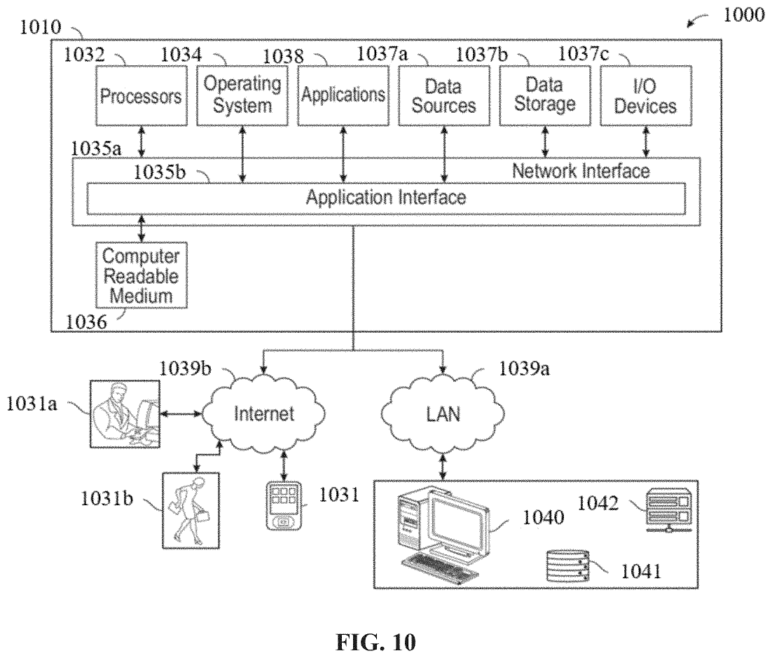

FIG. 10 illustrates a computer system 1010 enabling or comprising the systems and methods in accordance with some embodiments of the system. In some embodiments, the computer system 1010 can operate and/or process computer-executable code of one or more software modules of the aforementioned system and method. Further, in some embodiments, the computer system 1010 can operate and/or display information within one or more graphical user interfaces (e.g., HMIs) integrated with or coupled to the system.

In some embodiments, the computer system 1010 can comprise at least one processor 1032. In some embodiments, the at least one processor 1032 can reside in, or coupled to, one or more conventional server platforms (not shown). In some embodiments, the computer system 1010 can include a network interface 1035a and an application interface 1035b coupled to the least one processor 1032 capable of processing at least one operating system 1034. Further, in some embodiments, the interfaces 1035a, 1035b coupled to at least one processor 1032 can be configured to process one or more of the software modules (e.g., such as enterprise applications 1038). In some embodiments, the software application modules 1038 can include server-based software, and can operate to host at least one user account and/or at least one client account, and operate to transfer data between one or more of these accounts using the at least one processor 1032.

With the above embodiments in mind, it is understood that the system can employ various computer-implemented operations involving data stored in computer systems. Moreover, the above-described databases and models described throughout this disclosure can store analytical models and other data on computer-readable storage media within the computer system 1010 and on computer-readable storage media coupled to the computer system 1010 according to various embodiments. In addition, in some embodiments, the above-described applications of the system can be stored on computer-readable storage media within the computer system 1010 and on computer-readable storage media coupled to the computer system 1010. In some embodiments, these operations are those requiring physical manipulation of physical quantities. Usually, though not necessarily, in some embodiments these quantities take the form of one or more of electrical, electromagnetic, magnetic, optical, or magneto-optical signals capable of being stored, transferred, combined, compared and otherwise manipulated. In some embodiments, the computer system 1010 can comprise at least one computer readable medium 1036 coupled to at least one of at least one data source 1037a, at least one data storage 1037b, and/or at least one input/output 1037c. In some embodiments, the computer system 1010 can be embodied as computer readable code on a computer readable medium 1036. In some embodiments, the computer readable medium 1036 can be any data storage that can store data, which can thereafter be read by a computer (such as computer 1040). In some embodiments, the computer readable medium 1036 can be any physical or material medium that can be used to tangibly store the desired information or data or instructions and which can be accessed by a computer 1040 or processor 1032. In some embodiments, the computer readable medium 1036 can include hard drives, network attached storage (NAS), read-only memory, random-access memory, FLASH based memory, CD-ROMs, CD-Rs, CD-RWs, DVDs, magnetic tapes, other optical and non-optical data storage. In some embodiments, various other forms of computer-readable media 1036 can transmit or carry instructions to a remote computer 1040 and/or at least one user 1031, including a router, private or public network, or other transmission or channel, both wired and wireless. In some embodiments, the software application modules 1038 can be configured to send and receive data from a database (e.g., from a computer readable medium 1036 including data sources 1037a and data storage 1037b that can comprise a database), and data can be received by the software application modules 1038 from at least one other source. In some embodiments, at least one of the software application modules 1038 can be configured within the computer system 1010 to output data to at least one user 1031 via at least one graphical user interface rendered on at least one digital display.

In some embodiments, the computer readable medium 1036 can be distributed over a conventional computer network via the network interface 1035a where the system embodied by the computer readable code can be stored and executed in a distributed fashion. For example, in some embodiments, one or more components of the computer system 1010 can be coupled to send and/or receive data through a local area network (“LAN”) 1039a and/or an internet coupled network 1039b (e.g., such as a wireless internet). In some embodiments, the networks 1039a, 1039b can include wide area networks (“WAN”), direct connections (e.g., through a universal serial bus port), or other forms of computer-readable media 1036, or any combination thereof.

In some embodiments, components of the networks 1039a, 1039b can include any number of personal computers 1040 which include for example desktop computers, and/or laptop computers, or any fixed, generally non-mobile internet appliances coupled through the LAN 1039a. For example, some embodiments include one or more of personal computers 1040, databases 1041, and/or servers 1042 coupled through the LAN 1039a that can be configured for any type of user including an administrator. Some embodiments can include one or more personal computers 1040 coupled through network 1039b. In some embodiments, one or more components of the computer system 1010 can be coupled to send or receive data through an internet network (e.g., such as network 1039b). For example, some embodiments include at least one user 1031a, 1031b, is coupled wirelessly and accessing one or more software modules of the system including at least one enterprise application 1038 via an input and output (“I/O”) 1037c. In some embodiments, the computer system 1010 can enable at least one user 1031a, 1031b, to be coupled to access enterprise applications 1038 via an I/O 1037c through LAN 1039a. In some embodiments, the user 1031 can comprise a user 1031a coupled to the computer system 1010 using a desktop computer, and/or laptop computers, or any fixed, generally non-mobile internet appliances coupled through the internet 1039b. In some embodiments, the user can comprise a mobile user 1031b coupled to the computer system 1010. In some embodiments, the user 1031b can connect using any mobile computing 1031c to wireless coupled to the computer system 1010, including, but not limited to, one or more personal digital assistants, at least one cellular phone, at least one mobile phone, at least one smart phone, at least one pager, at least one digital tablets, and/or at least one fixed or mobile internet appliances.

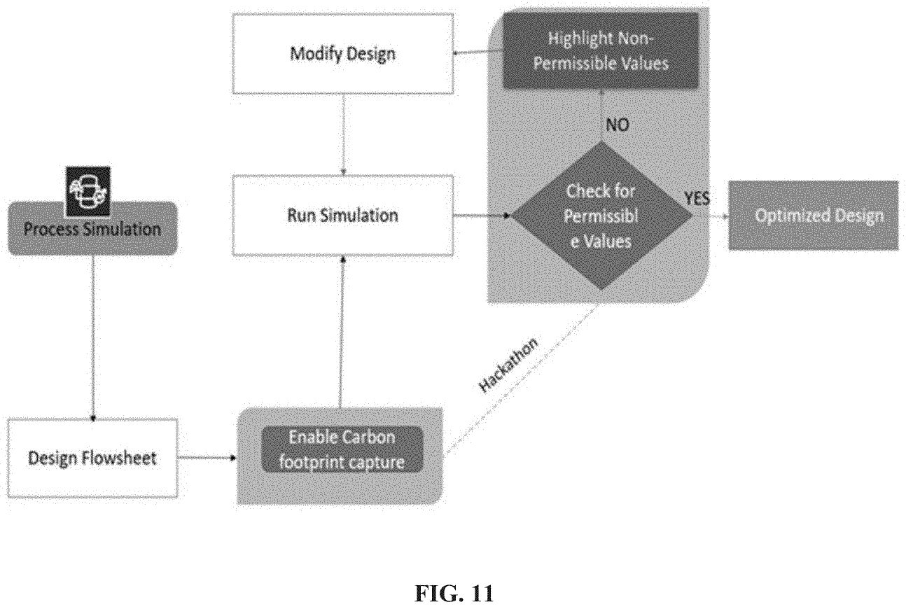

FIG. 11 is a flowchart depicting instruction for the execution of the systems and methods described herein.

The subject matter described herein are directed to technological improvements to the field of industrial construction by enabling multiple pollutant reduction simulation models to be connected to pollutant producing systems. The disclosure describes the specifics of how a machine including one or more computers comprising one or more processors and one or more non-transitory computer readable media implement the system and its improvements over the prior art. The instructions executed by the machine cannot be performed in the human mind or derived by a human using a pen and paper but require the machine to convert process input data to useful output data. Moreover, the claims presented herein do not attempt to tie-up a judicial exception with known conventional steps implemented by a general-purpose computer; nor do they attempt to tie-up a judicial exception by simply linking it to a technological field. Indeed, the systems and methods described herein were unknown and/or not present in the public domain at the time of filing, and they provide technologic improvements advantages not known in the prior art. Furthermore, the system includes unconventional steps that confine the claim to a useful application.

It is understood that the system is not limited in its application to the details of construction and the arrangement of components set forth in the previous description or illustrated in the drawings. The system and methods disclosed herein fall within the scope of numerous embodiments. The previous discussion is presented to enable a person skilled in the art to make and use embodiments of the system. Any portion of the structures and/or principles included in some embodiments can be applied to any and/or all embodiments: it is understood that features from some embodiments presented herein are combinable with other features according to some other embodiments. Thus, some embodiments of the system are not intended to be limited to what is illustrated but are to be accorded the widest scope consistent with all principles and features disclosed herein.

Some embodiments of the system are presented with specific values and/or setpoints. These values and setpoints are not intended to be limiting and are merely examples of a higher configuration versus a lower configuration and are intended as an aid for those of ordinary skill to make and use the system.

Furthermore, acting as Applicant's own lexicographer, Applicant imparts the explicit meaning and/or disavow of claim scope to the following terms:

Applicant defines any use of “and/or” such as, for example, “A and/or B,” or “at least one of A and/or B” to mean element A alone, element B alone, or elements A and B together. In addition, a recitation of “at least one of A, B, and C,” a recitation of “at least one of A, B, or C,” or a recitation of “at least one of A, B, or C or any combination thereof” are each defined to mean element A alone, element B alone, element C alone, or any combination of elements A, B and C, such as AB, AC, BC, or ABC, for example.

“Substantially” and “approximately” when used in conjunction with a value encompass a difference of 5% or less of the same unit and/or scale of that being measured.

“Simultaneously” as used herein includes lag and/or latency times associated with a conventional and/or proprietary computer, such as processors and/or networks described herein attempting to process multiple types of data at the same time. “Simultaneously” also includes the time it takes for digital signals to transfer from one physical location to another, be it over a wireless and/or wired network, and/or within processor circuitry.

As used herein, “can” or “may” or derivations there of (e.g., the system display can show X) are used for descriptive purposes only and is understood to be synonymous and/or interchangeable with “configured to” (e.g., the computer is configured to execute instructions X) when defining the metes and bounds of the system.

In addition, the term “configured to” means that the limitations recited in the specification and/or the claims must be arranged in such a way to perform the recited function: “configured to” excludes structures in the art that are “capable of” being modified to perform the recited function but the disclosures associated with the art have no explicit teachings to do so. For example, a recitation of a “container configured to receive a fluid from structure X at an upper portion and deliver fluid from a lower portion to structure Y” is limited to systems where structure X, structure Y, and the container are all disclosed as arranged to perform the recited function. The recitation “configured to” excludes elements that may be “capable of” performing the recited function simply by virtue of their construction but associated disclosures (or lack thereof) provide no teachings to make such a modification to meet the functional limitations between all structures recited. Another example is “a computer system configured to or programmed to execute a series of instructions X, Y, and Z.” In this example, the instructions must be present on a non-transitory computer readable medium such that the computer system is “configured to” and/or “programmed to” execute the recited instructions: “configure to” and/or “programmed to” excludes art teaching computer systems with non-transitory computer readable media merely “capable of” having the recited instructions stored thereon but have no teachings of the instructions X, Y, and Z programmed and stored thereon. The recitation “configured to” can also be interpreted as synonymous with operatively connected when used in conjunction with physical structures.

It is understood that the phraseology and terminology used herein is for description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The previous detailed description is to be read with reference to the figures, in which like elements in different figures have like reference numerals. The figures, which are not necessarily to scale, depict some embodiments and are not intended to limit the scope of embodiments of the system.

Any of the operations described herein that form part of the invention are useful machine operations. The invention also relates to a device or an apparatus for performing these operations. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general-purpose computer selectively activated or configured by one or more computer programs stored in the computer memory, cache, or obtained over a network. When data is obtained over a network the data can be processed by other computers on the network, e.g., a cloud of computing resources.

The embodiments of the invention can also be defined as a machine that transforms data from one state to another state. The data can represent an article, that can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. In some embodiments, the manipulation can be performed by a processor. In such an example, the processor thus transforms the data from one thing to another. Still further, some embodiments include methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

Although method operations are presented in a specific order according to some embodiments, the execution of those steps do not necessarily occur in the order listed unless explicitly specified. Also, other housekeeping operations can be performed in between operations, operations can be adjusted so that they occur at slightly different times, and/or operations can be distributed in a system which allows the occurrence of the processing operations at various intervals associated with the processing, as long as the processing of the overlay operations are performed in the desired way and result in the desired system output.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

We claim:

1. A system for integrating pollution absorbing structures into a simulation model comprising:
a simulation module,
a pollutant module, and
one or more computers comprising one or more processors and one or more non-transitory computer readable media, the one or more non-transitory computer readable media comprising program instructions stored thereon that when executed cause the one or more computers to:
generate, by the simulation module, a simulation environment that includes a toolbar, a simulation model library, and a simulation canvas;
generate, by the pollutant module, a pollution absorption model library comprising one or more pollutant equipment models configured to absorb various types of pollutant emissions;
execute, by the one or more processors, an interface connection between the pollutant module and the simulation module; and
add, by the one or more processors, the pollution absorption model library to the simulation model library upon the execution of the interface connection.

2. The system of claim 1,
wherein the toolbar comprises various buttons icons, and/or actuators to customize and/or store simulations built on the simulation canvas.

3. The system of claim 2,
wherein the simulation model library and the pollution absorption model library each comprise one or more model components that include icons that represent real equipment in a manufacturing process.

4. The system of claim 3,
wherein each of the one or more model components can be assigned various parameters that include equations that represent one or more of flowrate, temperature, pressure, and any conventional parameter found within a manufacturing facility that can be modeled mathematically.

5. The system of claim 4,
wherein a connection between two or more model components of the one or more model components results in a simulated structure; and
wherein upon the connection to each other on the simulation canvas, the simulation module is configured to analyze an effect that each of the one or more model components have on the simulated structure as well as an effect each of the one or more model components have on each other.

6. The system of claim 1, further comprising:
a geography module,
wherein the one or more non-transitory computer readable media further comprise program instructions stored thereon that when executed cause the one or more computers to:
generate, by the geography module, a graphical user interface configured to enable a user to input a geographic region where an actual system represented by a simulated model is and/or will be built; and
execute, by the geography module, an automatic loading of the one or more pollutant equipment models into the pollution absorption model library that comply with emission laws in the geographic region.

7. The system of claim 6,
wherein the one or more non-transitory computer readable media further comprise program instructions stored thereon that when executed cause the one or more computers to:
execute, by the geography module, an automatic determination of a geographical location where the simulated model is being executed; and
execute, by the geography module, the automatic loading of one or more pollutant equipment models into the pollution absorption model library based on the geographical location.

8. The system of claim 1,
wherein the simulation model library and the pollution absorption model library each comprise one or more model components that include icons that represent real equipment in a manufacturing process;
wherein the one or more model components in the simulation model library include one or more emission producing components;
wherein the one or more model components in the pollution absorption model library include one or more pollutant absorbing components;
wherein the one or more non-transitory computer readable media further comprise program instructions stored thereon that when executed cause the one or more computers to:
import, by the one or more processors, the one or more pollutant absorbing components into the simulation canvas; and
wherein the one or more pollutant absorbing components remain passive on the simulation canvas until connected to the one or more emission producing components.

9. The system of claim 8,
wherein the one or more non-transitory computer readable media further comprise program instructions stored thereon that when executed cause the one or more computers to:
execute, by the one or more processors, a simulation comprising only the one or more emission producing components if the one or more pollutant absorbing components are not connected to the one or more emission producing components on the simulation canvas; and
display, by the one or more processors, only resulting emissions and/or unmitigated pollutants on the simulation canvas of the one or more emission producing components if the one or more pollutant absorbing components are not connected.

10. The system of claim 9,
wherein the one or more non-transitory computer readable media further comprise program instructions stored thereon that when executed cause the one or more computers to:
display, by the one or more processors, mitigated emissions and/or mitigated pollutants on the simulation canvas if the one or more emission producing components and the one or more pollutant absorbing components are connected.

11. The system of claim 10,
wherein the simulation module is configured to interface with one or more supervisory control and data acquisition (SCADA) systems in order to control one or more actual components in a manufacturing process represented by the one or more model components on the simulation canvas.

12. The system of claim 11,
wherein the pollutant module is configured to categorize and/or sum all pollutants generated by the simulation.

13. The system of claim 12,
wherein the toolbar comprises various buttons icons, and/or actuators to customize and/or store simulations built on the simulation canvas.

14. The system of claim 13,
wherein each of the one or more model components can be assigned various parameters that include equations that represent one or more of flowrate, temperature, pressure, and any conventional parameter found within a manufacturing facility that can be modeled mathematically.

15. The system of claim 14,
wherein a connection between two or more model components of the one or more model components results in a simulated structure; and
wherein upon connection to each other on the simulation canvas, the simulation module is configured to analyze an effect each component on the simulation canvas has on the simulated structure as well as an effect each component has on each other.
